(19) United States
(12) Patent Application Publication
(10) Pub. No.: US 2005/0094447 A1
(43) Pub. Date: May 5, 2005

(54) Buffer memory management apparatus and method for reproducing interactive information storage medium, and interactive information storage medium

(75) Inventor: Hyun-kwon Chung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/971,090

(22) Filed: Oct. 25, 2004

(30) Foreign Application Priority Data
Oct. 29, 2003 (KR) 2003-75813

(51) Int. Cl. G11B 7/085

(52) U.S. Cl. 365/200

(57) ABSTRACT

A buffer memory management apparatus and method reproducing an interactive information storage medium, and the interactive information storage medium, the buffer memory management method including: collectively reading collective-processing interactive data from the information storage medium when the information storage medium is loaded in a reproducing device or in an initial execution of a predetermined application after the information storage medium is loaded in the reproducing device and loading the collective-processing interactive data in a buffer memory; and reading conditional-processing interactive data, which is conditionally read according to a user's input condition or a reproducing status of the information storage medium, and loading the conditional-processing interactive data in the buffer memory. Therefore, a response speed of a device reproducing an interactive information storage medium can be increased and compatibility between reproducing devices can be achieved since compaction of a buffer memory is unnecessary by minimizing memory fragmentation.

### CROSS-REFERENCE TO RELATED APPLICATION

This application claims the priority of Korean Patent Application No. 2003-75813, filed on Oct. 29, 2003 in the Korean Intellectual Property Office, the disclosure of which is incorporated herein in its entirety by reference.

### BACKGROUND OF THE INVENTION

1. Field of the Invention

The present invention relates to the control of a buffer memory, and more particularly, to a buffer memory management apparatus and method for reproducing an information storage medium on which interactive data is stored in order to reproduce AV data stored on the information storage medium in an interactive mode, and the interactive information storage medium.

2. Description of the Related Art

Interactive DVDs on which audio/video (AV) data and interactive data for reproducing the AV data in an interactive mode are stored together have been developed. The interactive data is a markup resource such as a plurality of markup documents, image files, graphic files, and java files. A markup document is written with a markup language such as a hypertext markup language (HTML) or an extended markup language (XML).

FIG. 1 illustrates a directory structure of data stored in a conventional interactive DVD. Referring to FIG. 1, a root directory includes a VIDEO_TS directory in which AV data is stored, an INTERACTIVE directory in which interactive data, such as markup documents are stored, and an OTHER-FILES directory.

The interactive DVD can be reproduced in two modes. One is a video mode in which only DVD AV data is reproduced and displayed like in the case of a typical DVD, and the other is an interactive mode in which the DVD AV data is reproduced with a markup document and displayed on a display window of the markup document. When an interactive DVD is reproduced using a personal computer (PC), if the interactive mode is selected by a user, a web browser operating in the PC analyzes and displays a markup document recorded on the interactive DVD. A DVD image is displayed in a display window defined by the markup document.

For example, when DVD-AV data is a movie, the movie may be shown on the display window of the markup document, and various kinds of additional information, such as a movie script, a synopsis, and pictures of actors and actresses, may be displayed in other portion of the markup document.

FIGS. 2A through 2C illustrate memory fragmentation generated when reproducing a conventional interactive DVD.

FIG. 2A shows a buffer memory 1 of an interactive DVD reproducing device, in which five files, i.e., A100.HTM, B101.PNG, C102.HTM, D104.JPG, and E104.SWF, required to output a picture from among a plurality of files stored in an interactive DVD are loaded.

FIG. 2B shows that the files B101.PNG and D104.JPG are deleted from the buffer memory 1 since they are not required for the picture output any more, and that files F105.CSS and H106.JS required for the picture output are newly loaded at locations in which the deleted files B101.PNG and D104.JPG were respectively stored. A plurality of memory fragmentations 11, 13, and 15 are generated by some loaded data deleted from the buffer memory 1 and other data loaded again as shown in FIG. 2B.

When a new file J107.HTM is loaded in the buffer memory 1 shown in FIG. 2B, since the buffer memory 1 is fragmented, a consecutive storage space cannot be secured. Accordingly, a new file cannot be loaded in the buffer memory 1. A memory compaction process is performed in order to load the new file in the buffer memory 1.

However, since the memory compaction process is complicated requiring many movements of data loaded in the memory, a response speed of a reproducing device in response to a user's demand decreases. Also, since a starting time of performing the compaction varies according to the buffer management methods of various reproducing devices, the compatibility between the reproducing devices for an interactive data storage medium may decrease.

### SUMMARY OF THE INVENTION

According to an aspect of the present invention, there is provided a buffer memory management apparatus and method for reproducing an information storage medium on which interactive data is stored, which can raise a response speed of a device reproducing the information storage medium and the compatibility between reproducing devices by removing a compaction process by minimizing memory fragmentation generated during a process of reproducing interactive data.

According to another aspect of the present invention, there is provided a buffer memory management method for reproducing an information storage medium on which interactive data is stored, the method including: collectively reading collective-processing interactive data from the information storage medium when the information storage medium is loaded in a reproducing device or in an initial execution of a predetermined application after the information storage medium is loaded in the reproducing device and loading the collective-processing interactive data in a buffer memory; and reading conditional-processing interactive data, which is conditionally read according to a user's input condition or a reproducing status of the information storage medium, and loading the conditional-processing interactive data in the buffer memory.

According to another aspect of the present invention, there is provided a buffer memory management apparatus for reproducing an information storage medium on which interactive data is stored, the apparatus including: a reader reading the interactive data; a buffer memory buffering the read interactive data; and a buffer controller controlling the reader to collectively read collective-processing interactive data from the information storage medium when the information storage medium is loaded in a reproducing device or in an initial execution of a predetermined application after the information storage medium is loaded in the reproducing device and loading the collective-processing interactive data read by the reader in the buffer memory.

According to another aspect of the present invention, there is provided an information storage medium on which interactive data to reproduce AV data in an interactive mode is stored, the medium including: collective-processing interactive data collectively read into a reproducing device when the information storage medium is loaded in the reproducing device or in an initial execution of a predetermined application after the information storage medium is loaded in the reproducing device; conditional-processing interactive data conditionally read into the reproducing device according to a user's input condition or a reproducing status of the information storage medium; and collective-processing interactive data list information including a list of the collective-processing interactive data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments taken in conjunction with the accompanying drawings of which:

FIG. 1 illustrates a directory structure of data stored on a conventional interactive DVD;

FIGS. 2A through 2C illustrate memory fragmentation generated when reproducing a conventional interactive DVD;

FIG. 3 is a configuration of an interactive data reproducing system according to an embodiment of the present invention;

FIG. 4 is a block diagram of a reproducing device shown in FIG. 3;

FIGS. 5A through 5F illustrate a buffer memory management operation according to an embodiment of the present invention;

FIGS. 6 and 7 illustrate management information of an interactive data buffer;

FIG. 8 is an example of an interactive data buffer in which interactive data is loaded;

FIG. 9 illustrates a flowchart of a buffer memory management method according to an embodiment of the present invention; and

FIG. 10 illustrates a flowchart of a method of deleting interactive data loaded in the interactive data buffer.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

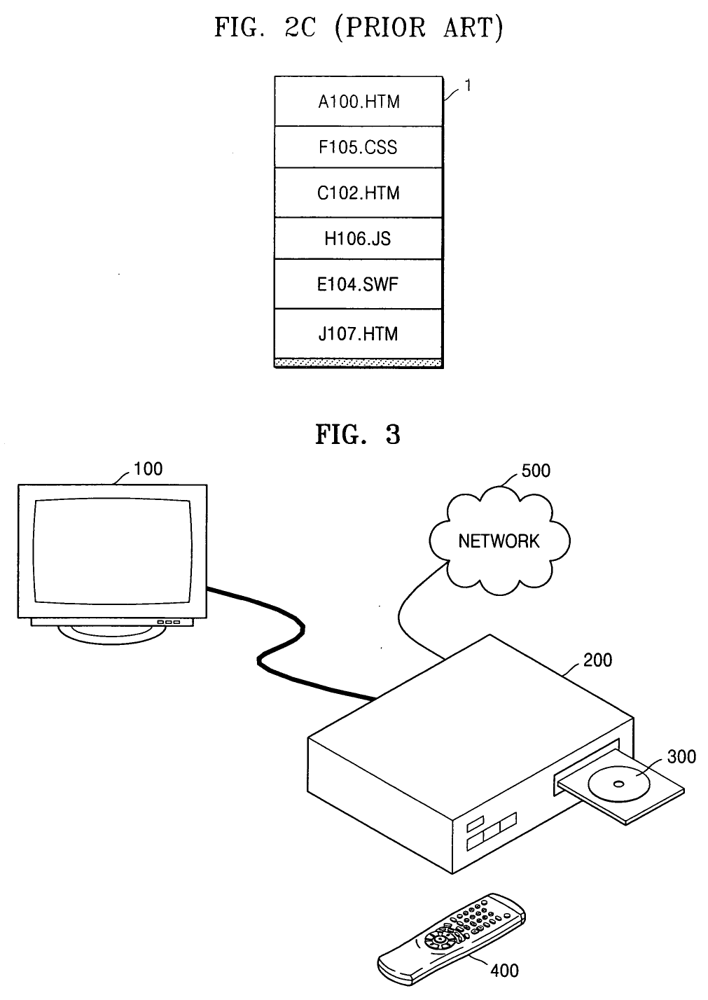

FIG. 3 is a configuration of an interactive data reproducing system according to an embodiment of the present invention. Referring to FIG. 3, the reproducing system includes a display device 100, a reproducing device 200, an interactive information storage medium 300, and a remote controller 400 as a user input device.

The reproducing device 200 reproduces AV data in an interactive mode according to an aspect of the present invention. The reproducing device 200 includes an information storage medium drive or a personal computer (PC) having the information storage medium drive. The reproducing device 200 receives a user's input from the remote controller 400. However, the user's input can be received by using various interface devices besides the remote controller 400.

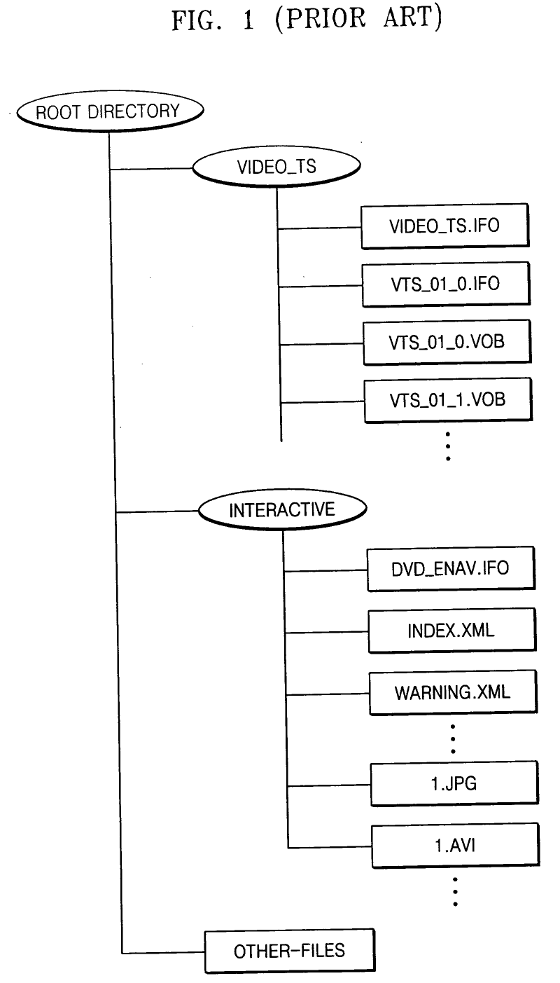

As shown in FIG. 1, AV data and interactive data for reproducing the AV data in the interactive mode are stored in the interactive information storage medium 300. Also, the interactive data stored in the interactive information storage medium 300 is classified into two kinds of collective-processing interactive data and conditional-processing interactive data. The collective-processing interactive data is collectively read into the reproducing device 200 when the interactive information storage medium 300 is loaded in the reproducing device 200 or in an initial execution of a predetermined application after the interactive information storage medium 300 is loaded in the reproducing device 200. The conditional-processing interactive data is conditionally read into the reproducing device 200 according to a user's input condition or a reproducing status of the interactive information storage medium 300.

Also, collective-processing interactive data list information including a list of the collective-processing interactive data is further stored on the interactive information storage medium 300. The reproducing device 200 reads the collective-processing interactive data into a buffer memory of the reproducing device 200 when the interactive information storage medium 300 is loaded in the reproducing device 200 or in an initial execution of a predetermined application after the interactive information storage medium 300 is loaded in the reproducing device 200.

When a network communication function exists in the reproducing device 200, the reproducing device 200 can reproduce the AV data and the interactive data stored on the interactive information storage medium 300 and reproduce AV data and interactive data by receiving the AV data and interactive data through a network 500.

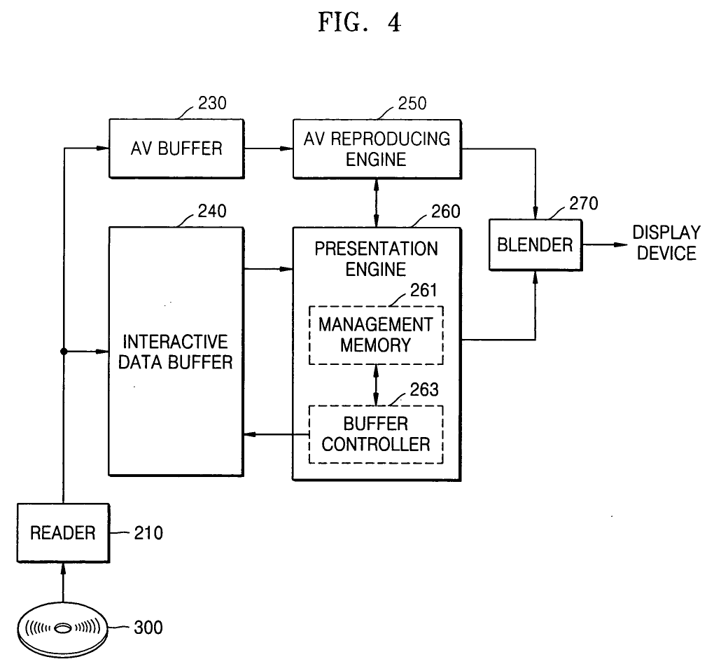

FIG. 4 is a block diagram of the reproducing device 200 shown in FIG. 3. Referring to FIG. 4, the reproducing device 200 includes a reader 210, an AV buffer 230, an interactive data buffer 240, an AV reproducing engine 250, a presentation engine 260, and a blender 270.

The reader 210 reads AV data and interactive data, such as a markup document for reproducing the AV data in the interactive mode, from the interactive information storage medium 300 and then transmits the AV data to the AV buffer 230 and the interactive data to the interactive data buffer 240.

The AV reproducing engine 250 decrypts the AV data stored in the AV buffer 230. For example, the AV reproducing engine 250 decrypts video data encrypted using an MPEG method or audio data and outputs the decrypted video data or audio data to the blender 270.

The presentation engine 260 reads and analyzes the markup document stored in the interactive data buffer 240 and outputs the result to the blender 270. Also, the presentation engine 260 includes a buffer controller 263 controlling the interactive data buffer 240 and a management memory 261 for managing the interactive data buffer 240.

The reader 210 reads collective-processing interactive data list information including a list of collective-processing interactive data stored in the interactive information storage medium 300 and stores the collective-processing interactive data list information in the management memory 261. The buffer controller 263 reads the collective-processing interactive data stored in the information storage medium 300 into the interactive data buffer 240 or conditional-processing interactive data into the interactive data buffer 240 according to a reproducing status, with reference to the collective-processing interactive data list information stored in the management memory 261.

The buffer controller 263 generates buffer memory management information indicating a location or the size of data loaded in the interactive data buffer 240 and stores the buffer memory management information in the management memory 261. Also, when new data is loaded in the interactive data buffer 240, or when loaded data is deleted from the interactive data buffer 240, the buffer controller 263 updates the buffer memory management information stored in the management memory 261.

The blender 270 synthesizes the AV data decrypted by the AV reproducing engine 250 and the markup document data analyzed by the presentation engine 260 and outputs the synthesizing result to the display device 100. The display device 100 provides a screen on which the AV data implied in the markup document is reproduced through a browser to a user.

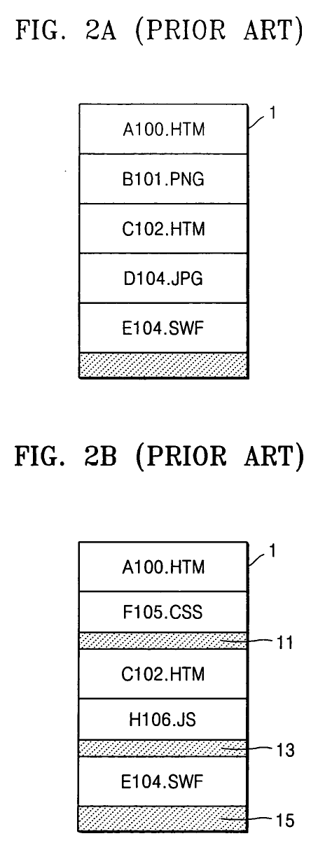

The memory fragmentation is commonly generated in the interactive data buffer 240 and is not generated in the AV buffer 230. In other words, since the AV data is consecutively loaded in the AV buffer 230 in a reproducing order, the memory fragmentation is not generated in the AV buffer 230. However, in the case of interactive data, since files are frequently loaded in or deleted from the interactive data buffer 240 according to a reproducing status or a user's input, the memory fragmentation is generated as shown in FIG. 2.

Therefore, the compaction process is not necessary since the memory fragmentation is minimized by controlling the interactive data buffer 240 using the buffer controller 263 included in the presentation engine 260.

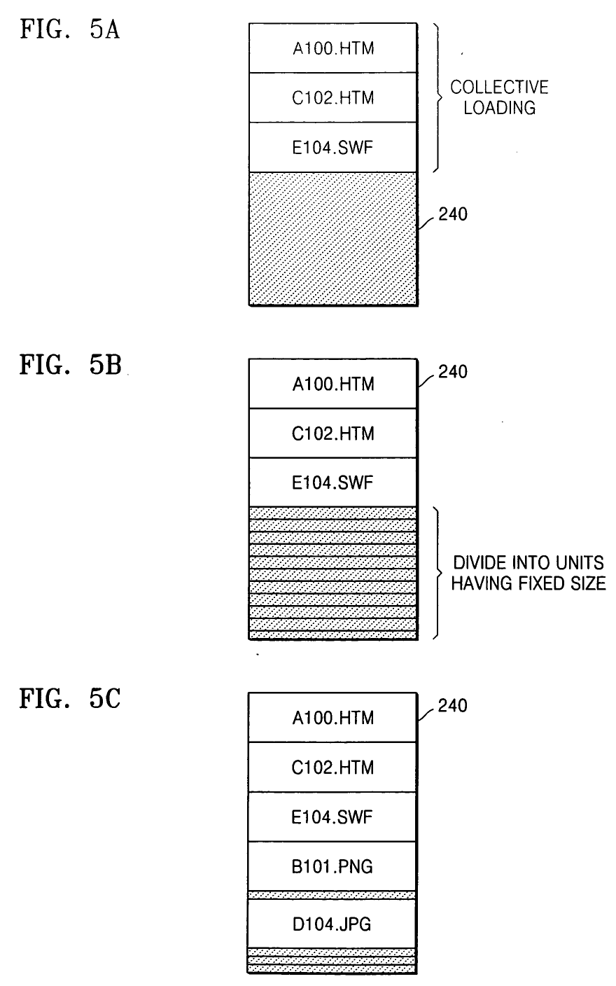

FIGS. 5A through 5F illustrate a buffer memory management operation according to an embodiment of the present invention.

When the interactive information storage medium 300 is loaded, the buffer controller 263 recognizes collective-processing interactive data to be collectively read in a current reproducing status with reference to the collective-processing interactive data list information read by the reader 210 and stored in the management memory 261. The collective-processing interactive data list preferably, but not necessarily, includes a path name with which files to be collectively read when the interactive information storage medium 300 is loaded in the reproducing device 200 or a path name with which files to be collectively read in an initial execution of an application after the interactive information storage medium 300 is loaded in the reproducing device 200.

When the buffer controller 263 recognizes the collective-processing interactive data to be collectively read in the current reproducing status, the reader 210 reads the collective-processing interactive data from the interactive information storage medium 300 and transmits the collective-processing interactive data to the interactive data buffer 240.

FIG. 5A shows three collective-processing interactive data files of A100.HTM, C102.HTM, and E104.SWF, which are collectively read and loaded into the interactive data buffer 240 without any gaps. The collective-processing interactive data is collectively deleted from the interactive data buffer 240 later. Therefore, the memory fragmentation is minimized.

After the collective-processing interactive data is loaded into the interactive data buffer 240, a memory area of the interactive data buffer 240 is divided into memory block units having a predetermined size as shown in FIG. 5B. By loading and deleting data in memory block units, the memory compaction process does not have to be performed, and it is easy to calculate the size of the loaded data and the size of the remaining memory area.

After the collective-processing interactive data is loaded into the interactive data buffer 240 and starts to be reproduced in the interactive mode by the reproducing device 200, if new interactive data, i.e., conditional-processing interactive data, is required, the new interactive data is loaded into the interactive data buffer 240 in the memory block units.

FIG. 5C shows that conditional-processing interactive data B101.PNG and D104.JPG are additionally loaded in the interactive data buffer 240 in the memory block units. Since the conditional-processing interactive data is loaded into the interactive data buffer 240 in the memory block units, the fragmentation may be generated in a memory block in which an end portion of a file is loaded by not filling the memory block with data. However, the size of the fragmented memory area is smaller than the size of the memory block.

FIG. 5D shows that the loaded data B101.PNG and D104.JPG are deleted from the interactive data buffer 240 and new conditional-processing interactive data F105.CSS and H106.JS are additionally loaded in the interactive data buffer 240. FIG. 5E shows that new conditional-processing interactive data J107.HTM is additionally loaded in the interactive data buffer 240.

Since the collective-processing interactive data is repeatedly demanded when the reproducing device 200 is executed or when a specific application is performed, the collective-processing interactive data is collectively loaded in the interactive data buffer 240. Likewise, the collective-processing interactive data is collectively deleted from the interactive data buffer 240 when the reproducing device 200 or the specific application ends. FIG. 5F shows that the three collective-processing interactive data files of A100.HTM, C102.HTM, and E104.SWF have been collectively deleted from the interactive data buffer 240.

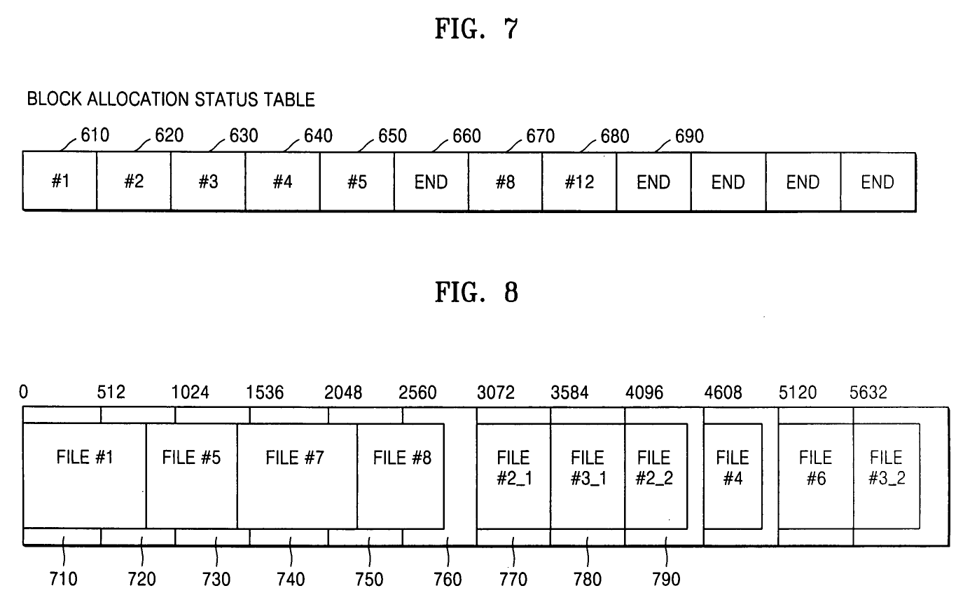

FIG. 8 is an example of the interactive data buffer 240 in which interactive data is loaded. Files FILE #1 through FILE #8 are loaded in the interactive data buffer 240 shown in FIG. 8. Files FILE #1, FILE #5, FILE #7, and FILE #8 are collective-processing interactive data, and files FILE #2, FILE #3, FILE #4, and FILE #6 are conditional-processing interactive data. The interactive data buffer 240 is divided into a plurality of memory blocks having a fixed size, such as a memory block #0 710, a memory block #1 720, a memory block #2, etc. In the present embodiment, the size of each memory block is 512 bytes.

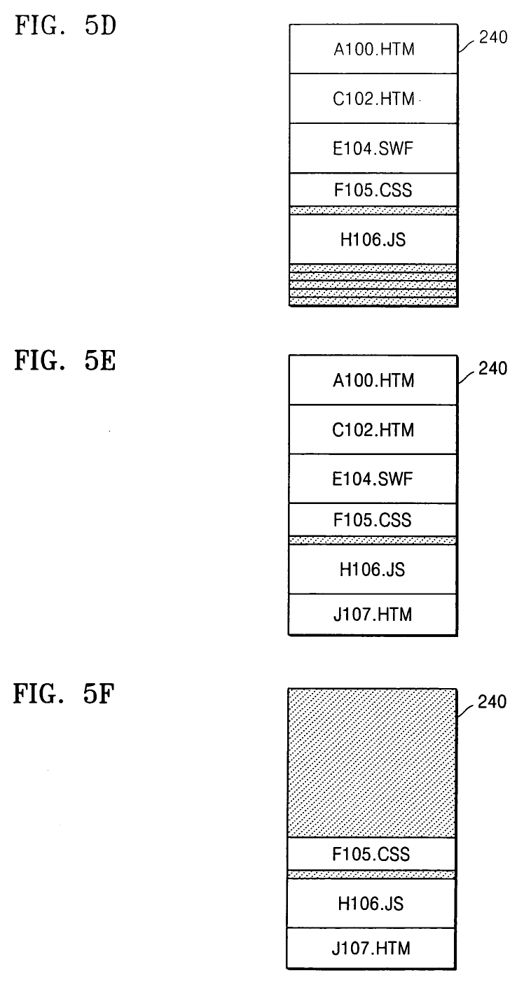

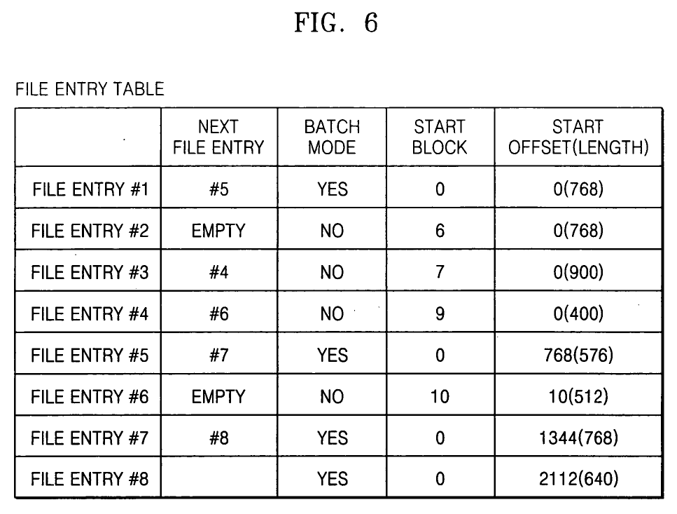

FIGS. 6 and 7 illustrate management information of the interactive data buffer 240. In detail, FIG. 6 shows a file entry table, which is one of the management information of the interactive data buffer 240, and FIG. 7 shows a block allocation status table, which is another one of the management information of the interactive data buffer 240. The file entry table and the block allocation status table shown in FIGS. 6 and 7 indicate a data loading status of the interactive data buffer 240 shown in FIG. 8.

The management information of the interactive data buffer 240, such as file entry table and the block allocation status table, indicates the location and the size of data loaded in the interactive data buffer 240 and is stored in the management memory 261. When new data is loaded in the interactive data buffer 240, or when loaded data is deleted from the interactive data buffer 240, the buffer memory management information is updated by the buffer controller 263.

Referring to FIG. 6, the file entry table includes a next file entry field, a batch mode field, a start block field, and a start offset field.

The next file entry indicates an entry number of a file recorded next to a current file. The batch mode indicates whether or not the current file is the collective-processing interactive data. That is, when the batch mode is “yes”, the current file is the collective-processing interactive data.

The start block indicates a memory block from which the current block begins in the interactive data buffer 240 divided into a plurality of memory blocks. The start offset indicates a distance from the start block to a location in which the current file is stored. A number in each parenthesis of the start offset field indicates the number of bytes of the current file.

For example, in a case of FILE ENTRY #1, a file recorded next to FILE #1 is FILE #5, FILE #1 is the collective-processing interactive data since the batch mode is “yes”, the start block is a 0th block, the start offset is 0, and FILE #1 has 768 bytes.

A plurality of fields, such as a field #0 610, a field #1 620, etc., included in the block allocation status table shown in FIG. 7 respectively corresponds to the memory block #0 710, the memory block #1 720, etc., included in the interactive data buffer 240 shown in FIG. 8.

If one data file cannot be stored in one memory block and is stored in another memory block, a number of each field included in the block allocation status table shown in FIG. 7 indicates a next memory block in which the data file stored in the memory block corresponding to the field is stored.

Referring to the file entry table shown in FIG. 6, since FILE #1 is stored in the memory block #0 and the length of FILE #1 is 768 bytes, the entire file of FILE #1 cannot be stored in the memory block #0 710, and another memory block is necessary. Referring to the block allocation status table shown in FIG. 7, since “#1” is recorded in the field #0 610, it can be known that the remaining data of FILE #1 which cannot be all stored in the memory block #0 710 is stored in the memory block #1 720.

According to the management information of the interactive data buffer 240, such as the file entry table and the block allocation status table, described above, the location and the size of data loaded in the interactive data buffer 240 can be known, and the size of the remaining memory area in which data is not loaded can be easily known.

In order for an interactive contents producer to confirm an amount of available memory of the interactive data buffer 240, it is preferable, but not necessary, that an interface for a predetermined program or information about the available memory space be provided. For example, the amount of the available memory of the interactive data buffer 240 is known using an [obj].getFreeSpace( ) method.

Also, in order to permit the interactive contents producer to know the number of files loaded in the interactive data buffer 240, it is preferable, but not necessary, that an interface for a predetermined program be provided. For example, the number of current files loaded in the interactive data buffer 240 is known using an [obj].getFileNumber( ) method.

A buffer memory management method according to an embodiment of the present invention will now be described on the basis of the configuration of the reproducing device 200 of the interactive information storage medium 300 shown in FIG. 4.

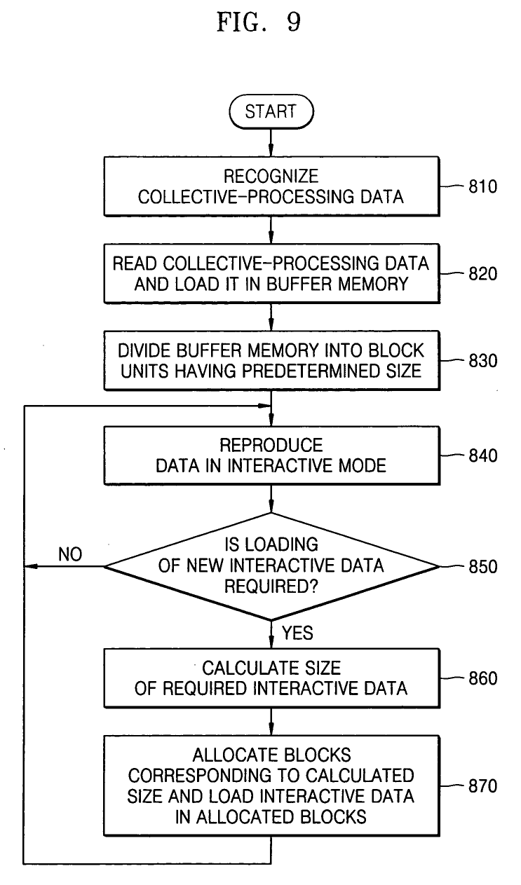

FIG. 9 illustrates a flowchart of a buffer memory management method according to an embodiment of the present invention.

When the interactive information storage medium 300 is loaded, the buffer controller 263 recognizes collective-processing interactive data to be collectively read in a current reproducing status with reference to collective-processing interactive data list information pre-read by the reader 210 and stored in the management memory 261 in operation 810. At this time, the size of a memory area Lpre which the collective-processing interactive data occupies in the interactive data buffer 240 is determined by Equation 1.
Lpre=sizeof(content) [Equation 1]
Here, sizeof(content) indicates the data size of content, and content indicates collective-processing interactive data.

The collective-processing interactive data read from the interactive information storage medium 300 by the reader 210 is loaded in an area of the interactive data buffer 240 having the size calculated by Equation 1 in operation 820.

After the collective-processing interactive data is loaded in the interactive data buffer 240, a memory area of the interactive data buffer 240 is divided into memory block units having a fixed size in operation 830. By loading and deleting data in memory block units, the memory compaction process does not have to be performed, and it is easy to calculate the size of the loaded data and the size of the remaining memory area. Also, the memory area of the interactive data buffer 240 may be divided into memory block units before the collective-processing interactive data is loaded in the interactive data buffer 240.

After the collective-processing interactive data is loaded in a buffer memory and starts to be reproduced by the reproducing device 200 in the interactive mode in operation 840, it is determined whether new interactive data, i.e., conditional-processing interactive data, is required in operation 850. If the new interactive data is required, the size of a memory area Lcond which the required conditional-processing interactive data occupies in the interactive data buffer 240 is calculated in operation 860.

At this time, the size of data Lcond which the conditional-processing interactive data occupies is determined by Equation 2.
Lcond=int((sizeof(content)+FBS−1)/FBS)*FBS [Equation 2]
Here, int(v) indicates an integer value of a v value, sizeof(c) indicates the data size of content, content indicates conditional-processing interactive data, and FBS indicates the size of a memory block.

For example, when FBS is 512 bytes and the size of the conditional-processing interactive data is 1048 bytes, Lcond is 1536 bytes.

Also, it is preferable, but not necessary, that the size of address information from which relative interactive data is read be included in the size of the interactive data determined by the sizeof(content) function of Equation 1 or Equation 2.

In operation 870, according to the calculated size of the data Lcond which the conditional-processing interactive data occupies, the buffer controller 263 allocates memory blocks in which the data having the calculated size is loaded and loads the data in the interactive data buffer 240.

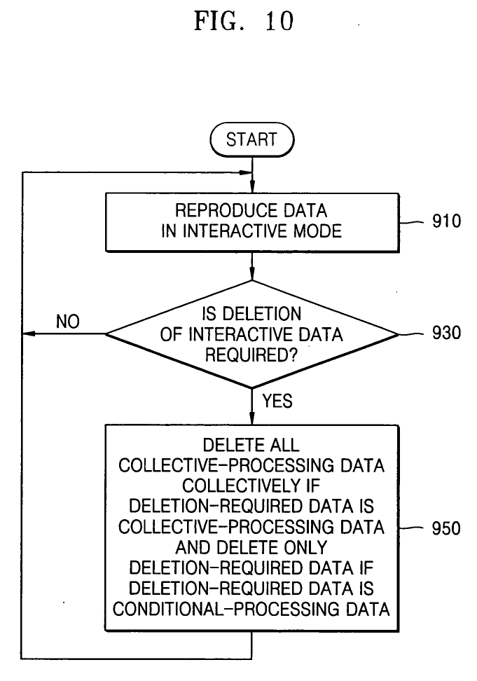

FIG. 10 illustrates a flowchart of a method of deleting interactive data loaded in the interactive data buffer 240.

While the interactive information storage medium 300 is reproduced in the interactive mode in operation 910, the buffer controller 263 determines whether a demand of deleting the interactive data loaded in the interactive data buffer 240 exists in operation 930. If the demand of deleting the interactive data exists, the buffer controller 263 deletes all the collective-processing interactive data loaded in the interactive data buffer 240 if the deletion-demanded data is the collective-processing interactive data, and deletes only relative conditional-processing interactive data from the interactive data buffer 240 if the deletion-demanded data is the conditional-processing interactive data in operation 950.

The present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer-readable medium having a computer-readable program code unit embodied therein causing a number of computer systems connected via a network to effect distributed processing.

As described above, according to an embodiment of the present invention, a response speed of a device reproducing an interactive information storage medium can be raised and compatibility between reproducing devices can be achieved by removing a compaction process by minimizing memory fragmentation. The memory fragmentation is minimized by classifying interactive data stored in the interactive information storage medium into collective-processing interactive data and conditional-processing interactive data and setting buffer management methods of the collective-processing interactive data and the conditional-processing interactive data to be different from each other when the interactive information storage medium is reproduced.

While this invention has been particularly shown and described with reference to embodiments thereof, it will be understood by those skilled in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

1. A buffer memory management method reproducing interactive data stored on an information storage medium, the method comprising:
collectively reading collective-processing interactive data from the information storage medium when the information storage medium is loaded in a reproducing device or in an initial execution of a predetermined application after the information storage medium is loaded in the reproducing device and loading the collective-processing interactive data in a buffer memory; and
reading conditional-processing interactive data, which is conditionally read according to a user's input condition or a reproducing status of the information storage medium, and loading the conditional-processing interactive data in the buffer memory.

2. The method of claim 1, wherein the loading of the collective-processing interactive data comprises:
determining the collective-processing interactive data with reference to collective-processing interactive data list information including a list of the collective-processing interactive data, which is stored in the information storage medium.

3. The method of claim 1, further comprising:
dividing the buffer memory into memory block units having a predetermined size before the loading of the collective-processing interactive data.

4. The method of claim 3, wherein the loading of the conditional-processing interactive data comprises:
determining a size the conditional-processing interactive data occupies in the buffer memory based on the size of the conditional-processing interactive data and the size of a memory block unit; and
loading the conditional-processing interactive data in at least one memory block of the buffer memory according to the determined size occupied by the conditional-processing interactive data.

5. The method of claim 4, wherein a size of a memory area occupied by the conditional-processing interactive data is determined by equation:
Lcond=int((sizeof(content)+FBS−1)/FBS)*FBS
wherein, int(v) indicates an integer value of a v value, sizeof(c) indicates a data size of content, content indicates the conditional-processing interactive data, and FBS indicates the size of the memory block unit.

6. The method of claim 1, wherein the loading of the collective-processing interactive data comprises:
determining a size of data Lpre, which the collective-processing interactive data occupies in the buffer memory, by equation:
Lpre=sizeof(content)
wherein, sizeof(content) indicates a data size of content, and content indicates the collective-processing interactive data.

7. The method of claim 1, further comprising:
generating buffer memory management information indicating a location or a size of the collective processing interactive data and/or the conditional-processing interactive data loaded in the buffer memory;
updating the buffer memory management information when new data is loaded in the buffer memory or when loaded data is deleted from the buffer memory.

8. The method of claim 1, wherein a size of the collective-processing interactive data or a size of the conditional-processing interactive data includes a size of address information of each type of data.

9. A buffer memory management apparatus reproducing interactive data stored on an information storage medium, the apparatus comprising:
a reader reading the interactive data;
a buffer memory buffering the read interactive data; and
a buffer controller controlling the reader to collectively read collective-processing interactive data from the information storage medium when the information storage medium is loaded in a reproducing device or in an initial execution of a predetermined application after the information storage medium is loaded in the reproducing device and loading the read collective-processing interactive data in the buffer memory.

10. The apparatus of claim 9, wherein the buffer controller controls the reader to read conditional-processing interactive data conditionally read according to a reproducing status of the information storage medium and loads the read conditional-processing interactive data in the buffer memory.

11. The apparatus of claim 9, wherein the buffer controller controls the reader to read the conditional-processing interactive data with reference to collective-processing interactive data list information including a list of the collective-processing interactive data, which is stored in the information storage medium.

12. The apparatus of claim 9, wherein the buffer controller divides the buffer memory into memory block units having a predetermined size before the read collective-processing interactive data is loaded in the buffer memory.

13. The apparatus of claim 10, wherein the buffer controller determines a size of buffer area memory the conditional-processing interactive data occupies in the buffer memory based on a size of the conditional-processing interactive data and a size of a memory block unit and loads the conditional-processing interactive data in at least one memory block unit of the memory buffer according to the determined size occupied by the conditional-processing interactive data.

14. The apparatus of claim 13, wherein the buffer controller determines a size of a memory area occupied by the conditional-processing interactive data occupies, by the following equation:
Lcond=int((sizeof(content)+FBS−1)/FBS)*FBS
wherein, int(v) indicates an integer value of a v value, sizeof(c) indicates a data size of the content, the content indicates conditional-processing interactive data, and FBS indicates the size of a memory block unit.

15. The apparatus of claim 9, wherein the buffer controller determines a size of a memory area occupied by the collective-processing interactive data in the buffer memory by equation:
Lpre=sizeof(content)
wherein, sizeof(content) indicates a data size of the content, and the content indicates collective-processing interactive data.

16. The apparatus of claim 9, further comprising:
a management memory managing the buffer memory; and
the buffer controller generating buffer memory management information indicating a location or a size of the interactive data loaded in the buffer memory, stores the buffer memory management information in the management memory, and updates the buffer memory management information when new data is loaded in the buffer memory or when loaded data is deleted from the buffer memory.

17. The apparatus of claim 14, wherein a size of the collective-processing interactive data or a size of the conditional-processing interactive data includes a size of address information of each data.

18. An information storage medium on which interactive data to reproduce AV data in an interactive mode is stored, the medium comprising:
collective-processing interactive data collectively read into a reproducing device when the information storage medium is loaded in the reproducing device or in an initial execution of a predetermined application after the information storage medium is loaded in the reproducing device;
conditional-processing interactive data conditionally read into the reproducing device according to a user's input condition or a reproducing status of the information storage medium; and
collective-processing interactive data list information including a list of the collective-processing interactive data.

19. The medium of claim 18, wherein the collective-processing interactive data is consecutively loaded in a buffer memory of the reproducing device.

20. The information storage medium of claim 18, wherein the conditional-processing interactive data is loaded in a buffer memory of the reproducing device in memory block units having a predetermined size.

21. A computer readable medium having recorded thereon a computer readable program performing a buffer memory management method reproducing interactive data stored on an information storage medium, the method comprising:
collectively reading collective-processing interactive data from the information storage medium when the information storage medium is loaded in a reproducing device or in an initial execution of a predetermined application after the information storage medium is loaded in the reproducing device and loading the collective-processing interactive data in a buffer memory; and
reading conditional-processing interactive data, which is conditionally read according to a user's input condition or a reproducing status of the information storage medium, and loading the conditional-processing interactive data in the buffer memory.

22. A buffer memory management apparatus comprising:
a reader reading interactive data and audio/visual (AV) data stored in an information storage medium;
an AV buffer memory storing the read AV data; and
an interactive data buffer memory storing the read interactive data,
wherein the interactive data is read from the information storage medium when the information storage medium is loaded in a reproducing device or in an initial execution of a predetermined application after the information storage medium is loaded in the reproducing device.

23. The apparatus of claim 22, further comprising a buffer controller generating buffer memory management information indicating a location and/or a size of data located in the interactive data buffer.

24. The apparatus of claim 22, wherein the interactive data includes collective-processing interactive data and conditional-processing interactive data.

25. The apparatus of claim 24, wherein the interactive data buffer includes a memory, which is divided into memory block units having a predetermined size after the collective-processing interactive data is loaded into the interactive data buffer.

26. The apparatus of claim 23, wherein the buffer controller updates the buffer memory management information when new data is loaded in the interactive data buffer, or when loaded data is deleted from the interactive data buffer.

27. The apparatus of claim 24, wherein the conditional-processing interactive data is read according to a user's input condition or a reproducing status of the information storage medium.

28. The method of claim 1, wherein memory fragmentation is minimized by classifying the interactive data into the collective-processing interactive data and the conditional-processing interactive data.

29. The method of claim 28, wherein a buffer memory management of the collective-processing interactive data is set different from another buffer memory management of the conditional-processing interactive data when the information storage medium is reproduced.
